(19) United States
(12) Patent Application Publication
(10) Pub. No.: US 2023/0103546 A1
(43) Pub. Date: Apr. 6, 2023

(54) IDENTIFYING WIRELESS COMMUNICATIONS CONNECTION OPTIONS

(71) Applicant: Iridium Satellite LLC, McLean, VA (US)

(72) Inventors: Charles H. WOLOSZYNSKI, Charlottesville, VA (US); Jordan D. IRVING, Queen Creek, AZ (US); Robert Dean SHOLL, Purcellville, VA (US); Gregory PELTON, Raleigh, NC (US)

(21) Appl. No.: 17/957,458

(22) Filed: Sep. 30, 2022

Related U.S. Application Data
(60) Provisional application No. 63/282,015, filed on Nov. 22, 2021.
(60) Provisional application No. 63/251,236, filed on Oct. 1, 2021.

(51) Int. Cl. H04B 7/185; H04W 76/10

(52) U.S. Cl. CPC H04B 7/18539; H04B 7/18526; H04W 76/10

(57) ABSTRACT

A method for accommodating communication between a personal communication device and a satellite communication system includes identifying likely positions of one or more satellites and determining an orientation position of the personal communication device to potentially facilitate a wireless communication connection between the personal communication device and at least one satellite. The orientation position may be provided at a graphical user interface of the personal communication device. A signal received from the satellite may be detected and a determination may be made whether the satellite is capable of establishing the wireless communication connection between the personal communication device and the satellite.

### CROSS-REFERENCE TO RELATED APPLICATIONS

This application claims the benefit of U.S. Provisional Patent Application No. 63/282,015 filed on Nov. 22, 2021 and U.S. Provisional Patent Application No. 63/251,236 filed on Oct. 1, 2021, the disclosures of each of which are incorporated herein by reference in their entirety.

### TECHNICAL FIELD

This disclosure relates generally to identifying wireless communications connection options, and, more specifically, to identifying wireless communications connection options for a communications device, such as, for example, a personal communications device like a smartphone or a tablet.

### BRIEF DESCRIPTION OF THE DRAWINGS

For a more complete understanding of the present disclosure, reference now is made to the following description taken in connection with the accompanying drawings.

FIG. 1 is a block diagram of an example of a communications device.

FIG. 2 is a block diagram of an example of a satellite communications system.

FIG. 3 is an example of beam laydown patterns for several satellites in a satellite communications system.

FIG. 4 is a flowchart illustrating an example of a process for identifying communications options for a communications device.

### DETAILED DESCRIPTION

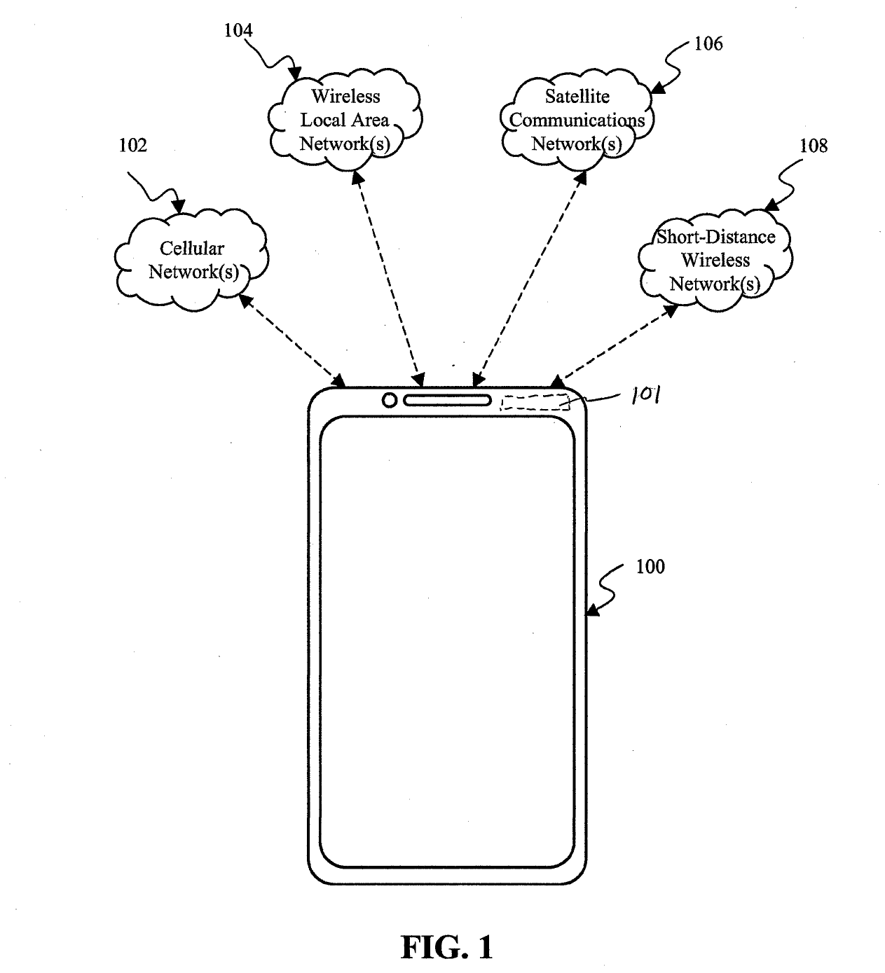

A communications device, such as a personal communications device (e.g., a smartphone or a tablet), may be configured to connect wirelessly to one or more different communications networks and/or one or more different wireless communications technologies or protocols. For example, as illustrated in FIG. 1, communications device 100 is configured to connect wirelessly to multiple different communications networks, including one or more cellular terrestrial communications networks 102, one or more wireless local area networks 104 (e.g., one or more Wi-Fi communications networks), one or more satellite communications networks 106 (e.g., one or more satellite communications networks provided by one or more satellites in low Earth orbit (“LEO”), one or more satellites in medium Earth orbit (“MEO”), and/or one or more satellites in geostationary orbit (“GEO”)), and one or more short-distance wireless networks 108 (e.g., one or more Bluetooth-enabled wireless personal area networks).

As described herein, different techniques may be employed to determine which of one or more available communications networks and/or wireless communications technologies or protocols a device like communications device 100 should attempt to establish a wireless connection with or otherwise use to engage in a communications session or otherwise send and/or receive communications wirelessly. Additionally or alternatively, different techniques may be employed to determine which of multiple different nodes of one or more different available communications networks a device like communications device 100 should attempt to establish a wireless connection with or otherwise use to engage in a communication session or otherwise send and/or receive communications wirelessly. Furthermore, different techniques may be employed to facilitate and/or improve the likelihood of establishing a wireless connection with one or more different nodes of one or more different communications networks available to a device like communications device 100.

For example, in some implementations, a device like communications device 100 may have a directional antenna (e.g., embedded antenna 101, and/or an antenna having a beam width of approximately 40 degrees or any other non-omnidirectional antenna) for the purposes of wirelessly communicating with one or more available satellite communications networks 106. In such implementations, the process of establishing a wireless connection between communications device 100 and one or more satellites in position and configured to provide communications service to communications device 100 may be facilitated, or the likelihood of successfully establishing a wireless connection between communications device 100 and any such satellite may be improved, by orienting communications device 100 such that the beam(s) of the directional antenna of communications device 100 are directed in the direction of the satellite.

However, an end user of a device like communications device 100 may not have knowledge of the position(s) of such satellite(s) relative to the communications device 100 and, consequently, may not know how to orient communications device 100 in order to facilitate the process of establishing a wireless connection with such satellite(s) and/or to increase the likelihood of successfully doing so. This problem may be complicated further if the satellite(s) are so-called non-stationary satellite(s) that are in constant motion relative to communications device 100, such as, for example, LEO or MEO satellites. Therefore, different techniques may be employed both (i) to identify the likely position(s) of one or more such satellites relative to the communications device 100, and (ii) to provide cues to the end user about how to orient communications device 100 to facilitate the process of establishing a wireless connection with a satellite and/or to increase the likelihood of successfully doing so based on the identified likely position(s) of the satellite(s) relative to the communications device 100. For example, in some implementations, communications device 100 may display visual instructions or information about how to orient communications device 100 and/or communications device 100 may provide auditory or haptic cues about how to orient communications device 100. Additionally or alternatively, in some implementations, communications device 100 may be configured to mechanically or otherwise steer its antenna and/or to automatically orient itself without any input by, or action on behalf of, an end user to facilitate the process of establishing a wireless connection with a satellite and/or to increase the likelihood of successfully doing so based on the identified likely position(s) of the satellite(s) relative to the communications device 100.

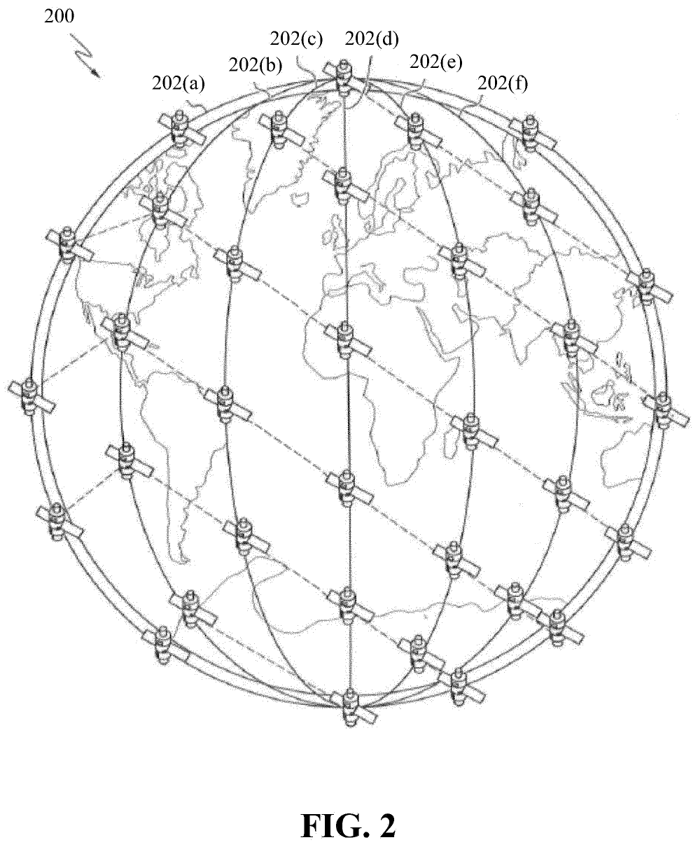

FIG. 2 is a block diagram of one example of a satellite communications system 200 that may provide a satellite communications network, such as, for example, one of satellite communications network(s) 106 illustrated in FIG. 1. Satellite communications system 200 is a constellation of LEO (e.g., at an altitude between the Earth's surface and approximately 2,000 km or 1,200 miles) communications satellites that provides mobile and/or fixed communications services (e.g., voice and data communications services) across much (if not substantially all) of the Earth.

In the particular example illustrated in FIG. 2, the constellation of satellites is arranged in 6 near-polar orbital planes 202(a)-202(f) of 11 satellites each. As illustrated in FIG. 2, individual satellites maintain communications crosslinks with neighboring satellites in the fore, aft, east, and west directions. As further illustrated in FIG. 2, the orbital planes 202(a)-202(f) converge near the poles and are farthest apart near the equator. As a consequence of their LEO orbits, the individual satellites are constantly in motion relative to fixed positions on Earth. For example, in an implementation where the satellites are in orbit at an altitude of approximately 785 km, the orbital velocity of individual satellites may be approximately 17,000 miles per hour, and individual satellites may complete a full orbit around the Earth in approximately 100 minutes.

In the case of a communications device like communications device 100 of FIG. 1 with a directional antenna, orienting communications device 100 in a particular manner relative to one or more of the satellites may facilitate the process of establishing a wireless connection with such satellite(s) and/or increase the likelihood of successfully doing so. However, an end user of a communications device like communications device 100 may not know how to so orient communications device 100, particularly given that the individual satellites are in constant motion relative to the location of communications device 100.

Referring again to FIG. 2, the constellation of satellites is configured so that the coverage footprints of the individual satellites collectively cover substantially all of the Earth. Near the equator, where the orbital planes 202(a)-202(f) are spaced relatively far apart, there may be relatively little overlap of the coverage footprints provided by individual satellites. However, further north and south of the equator, the orbital planes 202(a)-202(f) converge, and the coverage footprints provided by individual satellites increasingly overlap.

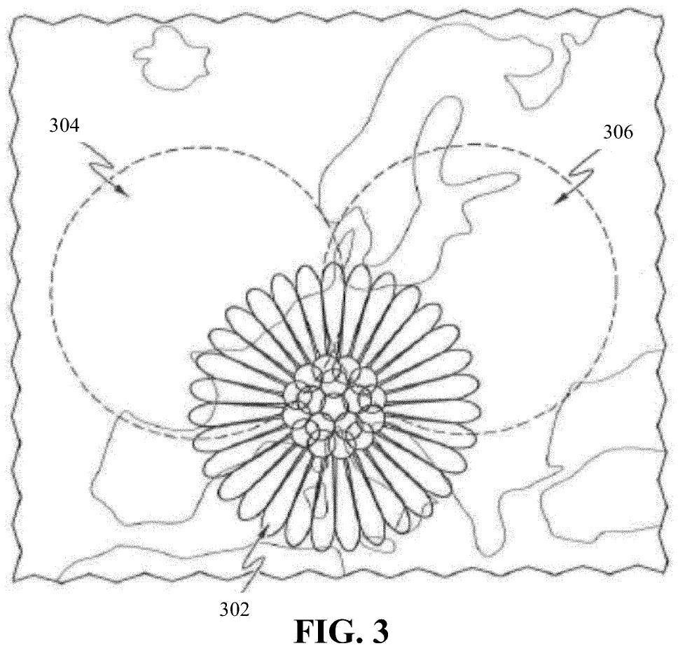

In some implementations, individual communications satellites may have phased array antennas that provide multiple beams that collectively define the coverage footprints of their respective satellites. In one particular implementation, each individual communications satellite may have a phased array antenna configured to provide 48 beams, which collectively define the coverage footprint for the satellite. For example, referring to FIG. 3, coverage footprint 302 of a first satellite is composed of 18 interior, substantially circular beams and 30 finger-shaped beams extending outward from the interior. Although not illustrated, each of coverage footprint 304 of a second, neighboring satellite and coverage footprint 306 of a third, neighboring satellite similarly may be composed of 18 interior, substantially circular beams and 30 finger-shaped beams extending outward from the interior.

As further illustrated in FIG. 3, coverage footprint 302 of the first satellite may cover much of Central and Western Europe at a particular point of time, while coverage footprint 304 of the second satellite may cover the United Kingdom and a region of the Atlantic Ocean and coverage footprint 306 of the third, neighboring satellite may cover much of Eastern Europe and a portion of Russia at the particular point of time. However, as also illustrated in FIG. 3, the coverage footprints 302, 304, and 306 of the three satellites also overlap significantly. As will be appreciated, as the orbital planes of the satellites converge as they get nearer to the north pole, the overlap between the three satellites (as well as other satellites) may become even more substantial.

Consequently, the further north (and south) a communications device is located, the more satellites might be in position to provide coverage for the communications device, which may introduce further complexity into the task of determining how to orient the communications device to facilitate the process of establishing a wireless connection with a satellite and/or to increase the likelihood of successfully doing so. Furthermore, due to the progressively increasing overlap of the coverage footprints of individual satellites as the orbital planes converge, in some implementations, one or more beams of one or more of the satellites may be turned off, for example, to reduce overlap and/or interference. For example, in some implementations, as satellites approach the poles, beams that are oriented in relatively eastwardly or westwardly directions may be turned off while beams that are oriented in relatively northwardly or southwardly directions may be kept on. This may further complicate the task of trying to appropriately orient a communications device because one or more of the satellites that is in position to provide coverage for the communications device may not actually be capable of providing coverage for the communications device due to one or more of their beams that otherwise would provide coverage in the area of the communications device being off.

Accordingly, as described herein, different techniques may be employed to identify the likely position(s) of one or more satellites (e.g., of a satellite communications system, such as, for example, the satellite communications system 200 of FIG. 2 or the Iridium satellite communications system) configured to provide coverage to the communications device at a point in time relative to the communications device and/or to provide cues to an end user about how to orient the communications device to facilitate the process of establishing a wireless connection with a satellite and/or to increase the likelihood of successfully doing so based on the identified likely position(s) of the satellite(s) relative to the communications device.

For example, in some implementations, a communications device may be configured to instruct, or otherwise suggest to, a user to scan the surrounding sky with the communications device (e.g., by holding the communications device in the air and turning around a full 360 degrees) to enable the communications device to attempt to sense the presence of and/or measure characteristics of signals transmitted by one or more satellites to determine if any satellites currently are providing coverage to the location of the user and, if so, to identify the location(s) of such satellites. This process also may enable the communications device to assess the likelihood of the communications device being able to successfully establish a wireless connection with such satellites. In some such implementations, the communications device may display textual and/or graphical cues to the user instructing the user to scan the surrounding sky with the communications device and/or the communications device may generate audio, haptic, or other cues to instruct the user to scan the surrounding sky with the communications device. Additionally or alternatively, the communications device itself or additional supporting equipment may be configured to automatically scan the surrounding sky and/or the communications device may be configured to mechanically or otherwise steer its antenna without any involvement of a user.

In one particular implementation, when the communications device senses the presence of a signal transmitted by a satellite while scanning the surrounding sky, the communications device may be configured to measure the power present in the received signal (e.g., in the form of a received signal strength indicator (“RSSI”)) as part of assessing the likelihood of the communications device being able to successfully establish wireless connections with the satellites. Additionally or alternatively, the communications device may be configured to measure the signal quality estimate (“SQE”) or some other measure of signal power or signal quality of a signal when the communications device senses the presence of a signal transmitted by a satellite while scanning the surrounding sky as part of assessing the likelihood of the communications device being able to successfully establish wireless connections with the satellites. For each signal transmitted by a satellite that the communications device detects the presence of as it scans the surrounding sky, the communications device may record the measured indication of signal power (e.g., RSSI) and/or signal quality (e.g., SQE) as well as the relative position of the communications device when the presence of the signal was detected (e.g., by using one or more accelerometers to track the movement of the device as the surrounding sky is scanned and then correlating the position of the device with physical directions using a compass). In implementations in which the communications device records the RSSI for each received signal, it may normalize each RSSI before recording it (e.g., to account for different transmit powers between the different satellites). Similarly, in implementations in which the communications device records the SQE for each received signal, it may normalize each SQE before recording it (e.g., to account for differences in waveforms between the different signals).

Upon completion of the scan of the surrounding sky, the communications device may determine the likelihood of successfully establishing a wireless connection with each satellite for which it detected the presence of a transmitted signal (e.g., based on the measured indications of signal power and/or signal quality for each signal) and then instruct, or otherwise guide, a user to return the communications device to one or more of the different recorded relative positions to attempt to establish a wireless connection with the corresponding satellite. For example, the communications device may instruct, or otherwise guide, the user to return the communications device to the different recorded relative positions in an order corresponding to a rank-ordered list of the likelihood of successfully establishing a wireless connection with each corresponding satellite until the communications device successfully establishes a wireless connection with a satellite, until the communications device has attempted but failed to successfully establish a wireless connection with some defined number of satellites, or until the communications device has attempted but failed to successfully establish a wireless connection with each of the satellites for which the communications detected the presence of a transmitted signal.

In some implementations, the communications device may display textual and/or graphical cues to the user to instruct, or otherwise guide, the user to return the communications device to such recorded relative positions and/or the communications device may generate audio, haptic, or other cues to instruct, or otherwise guide the user to return the communications device to such recorded relative positions. Additionally or alternatively, the communications device itself or additional supporting equipment may be configured to automatically return the communications to such recorded relative positions and/or the communications device may be configured to mechanically or otherwise steer its antenna to such recorded relative positions without any involvement of a user.

In some such implementations, the communications device may be configured to sense and/or measure the power and/or quality of certain specific components of signals transmitted by satellites. In such implementations, the pace at which the communications device scans the surrounding sky may depend on the frequency or periodicity of such signal components. For example, if the signal component is transmitted at a fixed frequency of 4.32 seconds and the communications device's antenna has a receive beam width of 30 degrees, then the communications device should pause for 4.32 seconds at each of twelve different positions separated by 30 degrees to cover the full 360 degrees of the scan, thereby requiring at least 51.84 seconds to complete the full scan.

In other implementations, a communications device may take advantage of advanced knowledge of the positions (or expected positions) of satellites to identify the likely position(s) of one or more satellites configured to provide coverage to the communications device and/or to provide cues to an end user about how to orient the communications device to facilitate the process of establishing a wireless connection with a satellite and/or to increase the likelihood of successfully doing so based on the identified likely position(s) of the satellite(s) relative to the communications device. For example, ephemeris data for one or more satellites, such as, for example, the satellites of satellite communications system 200 illustrated in FIG. 2, may be preloaded onto the communications device and/or such ephemeris data may be periodically or otherwise occasionally loaded onto the communications device (e.g., via download from the Internet or via communications with one or more of such satellites). In such implementations, the communications device may determine its position (e.g., based on global positioning system (“GPS”) data or some other global navigation satellite system (“GNSS”) data accessible to it) at a point in time and then identify, based on the ephemeris data, expected positions of one or more satellites that it assesses to be likely to be providing coverage to its position at that point in time. Thereafter, the communications device may instruct, or otherwise guide, (e.g., as described above) a user to orient the communications device in the direction of one or more of the satellites that it assesses to be likely to be providing coverage to its position at that point in time. Alternatively, in some implementations, the communications device may be configured to mechanically or otherwise steer its antenna and/or the communications device itself or additional supporting equipment may be configured to automatically orient the communications device in such fashion. In these and other disclosed implementations, the communications device may employ some combination of a motion detector (e.g., an accelerometer) and a direction sensor (e.g., a compass) to determine the current orientation of the communications device relative to the expected position of a satellite and/or how the communications device needs to be reoriented in order to be oriented in the direction of the expected position of the satellite.

In some implementations, the communications device may create, based on its determined position and the ephemeris data, a list of satellites currently expected to be in view of the communications device arranged in increasing order of expected distance from the communications device. Thereafter, the communications device may instruct, or otherwise guide, (e.g., as described above) a user to orient the communications device in the direction of one or more of the satellites currently expected to be in view of the communications device in the order of the expected distance between the communications device and the satellites until the communications device successfully establishes a wireless connection with a satellite, until the communications device has attempted but failed to successfully establish a wireless connection with some defined number of satellites, or until the communications device has attempted but failed to successfully establish a wireless connection with each of the satellites currently expected to be in view of the communications device. Alternatively, in some implementations, the communications device may be configured to mechanically or otherwise steer its antenna and/or the communications device itself or additional supporting equipment may be configured to automatically orient the communications device as described above.

In some cases, the beam width of the communications device's antenna may be wide enough that the communications device may be considered to be oriented in the direction of multiple satellites expected to be in view of the communications device at the same time. Therefore, in some implementations, the communications device may attempt to establish a wireless connection with any such satellite while so oriented and, if the communications device proves unsuccessful at establishing a wireless connection from such orientation at such time, the communications device may not later instruct, or otherwise guide, the user to return the communications device to the same or a similar orientation for the purposes of trying to establish a wireless connection with a device that is expected to be further away from the communications device.

In some implementations, a communications device may take advantage of advanced knowledge of the expected coverage footprints and/or expected beam patterns of satellites as well as advanced knowledge of the positions (or expected positions) of satellites to identify the likely position(s) of one or more satellites configured to provide coverage to the communications device and/or to provide cues to an end user about how to orient the communications device to facilitate the process of establishing a wireless connection with a satellite and/or to increase the likelihood of successfully doing so based on the identified likely position(s) of the satellite(s) relative to the communications device.

For example, consider the example of the LEO satellite communications system 200 illustrated in FIG. 2 in which the satellites are arranged in substantially polar planes such that the planes, and the coverage footprints of individual satellites, converge near the poles. As described above in connection with FIG. 2, in some implementations of such a system, one or more beams of individual satellites may be turned off, or the coverage footprints of individual satellites otherwise may be reduced, as the satellites near the poles, for example, to reduce overlap and/or interference. For example, in some particular implementations of such a system, as an individual satellite nears a pole, beams that are oriented in relatively eastwardly or westwardly directions may be turned off while beams that are oriented in relatively northwardly or southwardly directions may be kept on. Consequently, in such implementations, the expected distance between a communications device and a first satellite expected to be in view of the communications device in an eastwardly or westwardly direction relative to the communications device may be less than the expected distance between the communications device and a second satellite expected to be in view of the communications device in a northwardly or southwardly direction relative to the communications device, but the first satellite may not actually be capable of providing coverage to the communications device because its coverage footprint has been reduced (e.g., by turning off one or more of its beams) and does not currently cover the location of the communications device.

Accordingly, in such implementations, a communications device may take its current position, the expected positions of the satellites, and the expected coverage footprints and/or expected beam patterns of the satellites into account when attempting to identify the likely position(s) of one or more satellites configured to provide coverage to the communications device and/or to provide cues to an end user about how to orient the communications device to facilitate the process of establishing a wireless connection with a satellite and/or to increase the likelihood of successfully doing so based on the identified likely position(s) of the satellite(s) relative to the communications device.

For example, in some implementations, a communications device may determine its current position (e.g., based on GPS data or some other GNSS data accessible to it). If the communications device determines that it is below (or at or below) a threshold latitude (e.g., below 55° north or 55° south), the communications device then may identify (e.g., based on ephemeris data) expected positions of one or more satellites that it assesses to be likely to be providing coverage to its position at that point in time and create a list of satellites currently expected to be in view of the communications device arranged in increasing order of expected distance from the communications device. Thereafter, the communications device may instruct, or otherwise guide, (e.g., as described above) a user to orient the communications device in the direction of one or more of the satellites currently expected to be in view of the communications device in order of the expected distance between the communications device and the satellites until the communications device successfully establishes a wireless connection with a satellite, until the communications device has attempted but failed to successfully establish a wireless connection with some defined number of satellites, or until the communications device has attempted but failed to successfully establish a wireless connection with each of the satellites currently expected to be in view of the communications device. Additionally or alternatively, the communications device may be configured to mechanically or otherwise steer its antenna and/or the communications device itself or additional supporting equipment may be configured to automatically orient the communications device as described above without any involvement of a user.

Alternatively, if the communications device determines that it is at or above (or above) the threshold latitude (e.g., at or above 55° north or 55° south), the communications device then may identify (e.g., based on ephemeris data) expected positions of one or more satellites that it assesses to be likely to be providing coverage to its position at that point in time and create a list of satellites currently expected to be in view of the communications device arranged in increasing order of expected distance from the communications device. Thereafter, the communications device may instruct, or otherwise guide, (e.g., as described above) a user to orient the communications device in the direction of the satellite currently expected to be in view of the communications device that it determined to be closest to it. In the event that the communications device is unable to establish a wireless connection with a satellite while so oriented, the communications device then may instruct, or otherwise guide, (e.g., as described above) a user to orient the communications device in the direction of the satellite currently expected to be in view of the communications device that is next closest to it and that is (i) in a generally northwardly direction relative to the communications device (e.g., having an azimuth angle within a range of approximately 315°-45°, where 0° is due north) if the communications device is at or above the threshold latitude in the northern hemisphere, or (ii) in a generally southwardly direction relative to the communications device (e.g., having an azimuth angle within a range of approximately 135°-225°, where 0° is due north) if the communications device is at or above the threshold hemisphere in the southern hemisphere. In the event that the communications device is unable to establish a wireless connection with a satellite while so oriented, the communications device then may instruct, or otherwise guide, (e.g., as described above) a user to orient the communications device in the direction of the satellite currently expected to be in view of the communications device that is next closest to it and that is (i) in a generally southwardly direction relative to the communications device (e.g., having an azimuth angle within a range of approximately 135°-225°, where 0° is due north) if the communications device is at or above the threshold latitude in the northern hemisphere, or (ii) in a generally northwardly direction relative to the communications device (e.g., having an azimuth angle within a range of approximately 315°-45°, where 0° is due north) if the communications device is at or above the threshold latitude in the southern hemisphere.

In some alternative implementations, if the communications device determines that it is at or above (or above) the threshold latitude, the communications device may instruct, or otherwise guide, (e.g., as described above) a user to orient the communications device in the direction of the satellite currently expected to be in view of the communications device that is closest to it and that is (i) in a generally northwardly direction relative to the communications device (e.g., having an azimuth angle within a range of approximately 315°-45°, where 0° is due north) if the communications device is at or above the threshold latitude in the northern hemisphere, or (ii) in a generally southwardly direction relative to the communications device (e.g., having an azimuth angle within a range of approximately 135°-225°, where 0° is due north) if the communications device is at or above the threshold latitude in the southern hemisphere. In the event that the communications device is unable to establish a wireless connection with a satellite while so oriented, the communications device then may instruct, or otherwise guide, (e.g., as described above) a user to orient the communications device in the direction of the satellite currently expected to be in view of the communications device that is next closest to it and that is (i) in a generally southwardly direction relative to the communications device (e.g., having an azimuth angle within a range of approximately 135°-225°, where 0° is due north) if the communications device is at or above the threshold latitude in the northern hemisphere, or (ii) in a generally northwardly direction relative to the communications device (e.g., having an azimuth angle within a range of approximately 315°-45°, where 0° is due north) if the communications device is at or above the threshold latitude in the southern hemisphere.

In still other alternative implementations, if the communications device determines that it is at or above (or above) the threshold latitude, the communications device may instruct, or otherwise guide, (e.g., as described above) a user to orient the communications device in the direction of one or more of the satellites currently expected to be in view of the communications device that either are generally in a northwardly direction relative to the communications device (e.g., having an azimuth angle within a range of approximately 315°-45°, where 0° is due north) or a southwardly direction relative to the communications device (e.g., having an azimuth angle within a range of approximately 135°-225°, where 0° is due north) in order of the expected distance between the communications device and the satellites until the communications device successfully establishes a wireless connection with a satellite, until the communications device has attempted but failed to successfully establish a wireless connection with some defined number of satellites, or until the communications device has attempted but failed to successfully establish a wireless connection with each of the satellites currently expected to be in view of the communications device. In such implementations, the communications device may not instruct, or otherwise guide, (e.g., as described above) a user to orient the communications device in generally eastwardly or westwardly directions if the communications device is at or above the threshold latitude.

It will be appreciated that, instead of instructing, or otherwise guiding, a user to orient the communications device as described above, in some implementations, the communications device may be configured to mechanically or otherwise steer its antenna and/or the communications device itself or additional supporting equipment may be configured to automatically orient the communications device as described above without any involvement of a user.

In some implementations, a communications device may take advantage of advanced knowledge of the direction satellites are travelling as well as advanced knowledge of the positions (or expected positions) of satellites to identify the likely position(s) of one or more satellites configured to provide coverage to the communications device and/or to provide cues to an end user about how to orient the communications device to facilitate the process of establishing a wireless connection with a satellite and/or to increase the likelihood of successfully doing so based on the identified likely position(s) of the satellite(s) relative to the communications device.

For example, consider the example of the LEO satellite communications system 200 illustrated in FIG. 2 in which the satellites are arranged in substantially polar planes such that the planes converge near the poles. In such an implementation, an individual satellite nears a pole travelling in one direction (e.g., north) and then, after crossing over or substantially near the pole, travels away from the pole in the opposite direction (e.g., south). Additionally or alternatively, in such an implementation, satellites in one plane may travel in an opposite direction (e.g., north) from satellites in an adjacent plane (e.g., south). In some cases, two adjacent planes where the satellites in one plane travel in the opposite direction from satellites in the adjacent plane may be referred to as a “seam” in the constellation of satellites.

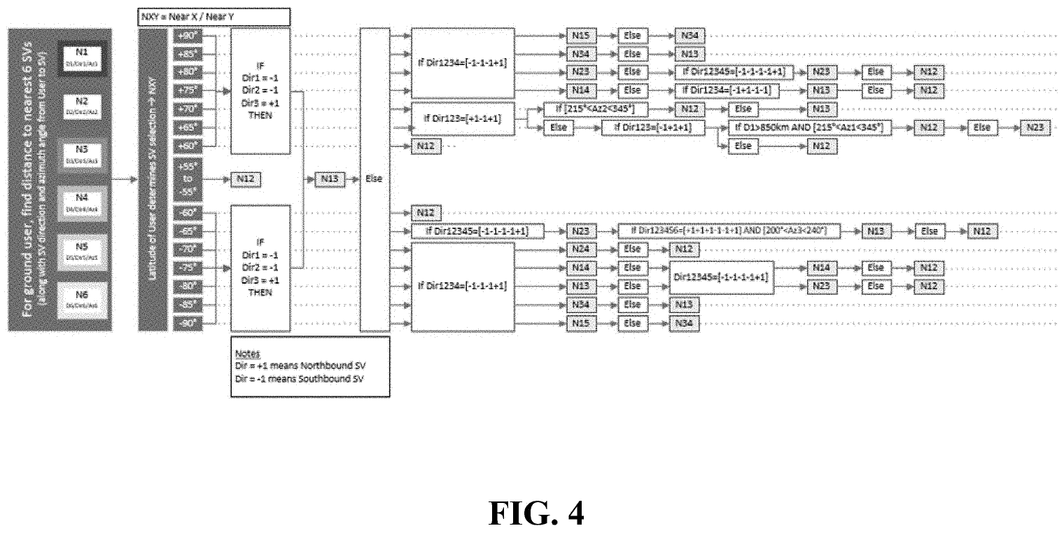

Referring now to FIG. 4, an example of a communications device taking its current position, the expected positions of one or more satellites (e.g., from the satellite communications system 200 of FIG. 2 or the Iridium satellite communications system), and the directions such satellites are travelling into account when attempting to identify the likely position(s) of one or more satellites configured to provide coverage to the communications device and/or to provide cues to an end user about how to orient the communications device to facilitate the process of establishing a wireless connection with a satellite and/or to increase the likelihood of successfully doing so based on the identified likely position(s) of the satellite(s) relative to the communications device is described.

As illustrated in FIG. 4, the communications device determines its current position (e.g., based on GPS data or some other GNSS data accessible to it) and then determines the distance between the communications device and the expected positions of the six satellites expected to be closest to the communications device (e.g., based on ephemeris data). In addition, for each of these six satellites expected to be closest to the communications device, the communications device also determines the direction the satellite is travelling and the azimuth angle to the satellite (e.g., based on ephemeris data). Based on this information, the communications device then may identify two of the six satellites expected to be closest to the communications device as the two best candidate satellites for the communications device to attempt to establish a wireless connection with. Thereafter, the communications device may instruct, or otherwise guide, (e.g., as described above) a user to orient the communications device in the direction of the best candidate and thereafter the second-best candidate in an attempt to establish a wireless connection with one of the two candidate satellites. Alternatively, instead of instructing, or otherwise guiding, a user to orient the communications device as described above, in some implementations, the communications device may be configured to mechanically or otherwise steer its antenna and/or the communications device itself or additional supporting equipment may be configured to automatically orient the communications device in the directions of the two best candidate satellites.

For example, as illustrated in FIG. 4, if the communications device determines that it is between 55° north and 55° south latitude, the communications device then may determine that the two satellites expected to be closest to the communications device are the two best candidate satellites for the communications device to attempt to establish a wireless connection with.

Alternatively, if the communications device determines that it is between 55-90° north latitude, the communications device may consider the directions that the three satellites expected to be closest to the communications device are travelling. If the two satellites expected to be closest to the communications device are travelling south and the satellite expected to be third closest to the communications device is travelling north, the communications device may determine that the satellite expected to be closest to the communications device and the satellite expected to be third closest to the communications device are the two best candidate satellites for the communications device to attempt to establish a wireless connection with.

If it is not true that the two satellites expected to be closest to the communications device are travelling south and the satellite expected to be third-closest to the communications device is travelling north and if the communications device is between 55-60° north latitude, the communications device may determine that the two satellites expected to be closest to the communications device are the two best candidate satellites for the communications device to attempt to establish a wireless connection with.

If it is not true that the two satellites expected to be closest to the communications device are travelling south and the satellite expected to be third-closest to the communications device is travelling north and if the communications device is between 60-70° north latitude, the communications device may check the directions that the three satellites expected to be closest to the communications device are travelling to determine if the satellite expected to be closest to the communications device is travelling north, the satellite expected to be second-closest to the communications device is travelling south, and the satellite expected to be third-closest to the communications device is travelling north. If that's the case, the communications device then may check the azimuth angle to the satellite expected to be second-closest to the communications device to determine if it is within the range between 215-345° (where 0° is due north), and, if it is, the communications device may determine that the two satellites expected to be closest to the communications device are the two best candidate satellites for the communications device to attempt to establish a wireless connection with. If the azimuth angle to the satellite expected to be second-closest to the communications device is not within the range between 215-345°, the communications device may determine that the satellite expected to be closest to the communications device and the satellite expected to be third closest to the communications device are the two best candidate satellites for the communications device to attempt to establish a wireless connection with. If it is not the case that the satellite expected to be closest to the communications device is travelling north, the satellite expected to be second-closest to the communications device is travelling south, and the satellite expected to be third-closest to the communications device is travelling north, the communications device may check to see if the satellite expected to be closest to the communications device is travelling south while the satellites that are expected to be second- and third-closest to the communications device are travelling north, and, if that's the case, the communications device may check if the expected distance between the communications device and the satellite expected to be closest to the communications device is greater than 850 km and if the azimuth angle to the satellite expected to be closest to the communications device is within the range between 215-345° (where 0° is due north). If both are true, the communications device may determine that the two satellites expected to be closest to the communications device are the two best candidate satellites for the communications device to attempt to establish a wireless connection with. If either is false, the communications device may determine that the satellite expected to be second-closest and the satellite expected to third-closest to the communications device are the two best candidate satellites for the communications device to attempt to establish a wireless connection with. Alternatively, if it is not the case that the satellite expected to be closest to the communications device is travelling south while the satellites that are expected to be second- and third-closest to the communications device are travelling north, the communications device may determine that the two satellites expected to be closest to the communications device are the two best candidate satellites for the communications device to attempt to establish a wireless connection with.

If it is not true that the two satellites expected to be closest to the communications device are travelling south and the satellite expected to be third-closest to the communications device is travelling north and if the communications device is between 70-75° north latitude, the communications device may check the directions that the four satellites expected to be closest to the communications device are travelling to determine if the three satellites expected to be closest to the communications device are travelling south and the satellite expected to be fourth-closest to the communications device is travelling north. If that's the case, the communications device may determine that the satellite expected to be nearest to the communications device and the satellite expected to be fourth-closest to the communications device are the two best candidate satellites for the communications device to attempt to establish a wireless connection with. If it's not true that the three satellites expected to be closest to the communications device are travelling south and the satellite expected to be fourth-closest to the communications device is travelling north, the communications device may determine if the satellite expected to be closest to the communications device and the satellites expected to be third- and fourth-closest to the communications device are travelling south and the satellite expected to be second-closest to the communications device is travelling north. If that's the case, the communications device may determine that the satellite expected to be closest to the communications device and the satellite expected to be third-closest to the communications device are the two best candidate satellites for the communications device to attempt to establish a wireless connection with. Otherwise, the communications device may determine that the two satellites expected to be closest to the communications device are the two best candidate satellites for the communications device to attempt to establish a wireless connection with.

If it is not true that the two satellites expected to be closest to the communications device are travelling south and the satellite expected to be third-closest to the communications device is travelling north and if the communications device is between 75-80° north latitude, the communications device may check the directions that the four satellites expected to be closest to the communications device are travelling to determine if the three satellites expected to be closest to the communications device are travelling south and the satellite expected to be fourth-closest to the communications device is travelling north. If that's the case, the communications device may determine that the satellite expected to be second-closest to the communications device and the satellite expected to be third-closest to the communications device are the two best candidate satellites for the communications device to attempt to establish a wireless connection with. If it's not true that the three satellites expected to be closest to the communications device are travelling south and the satellite expected to be fourth-closest to the communications device is travelling north, the communications device may check the directions that the five satellites expected to be closest to the communications device are travelling to determine if the four satellites expected to be closest to the communications device are travelling south and the satellite expected to be fifth-closest to the communications device is travelling north. If that's the case, the communications device may determine that the satellite expected to be second-closest to the communications device and the satellite expected to be third-closest to the communications device are the two best candidate satellites for the communications device to attempt to establish a wireless connection with. Otherwise, the communications device may determine that the two satellites expected to be closest to the communications device are the two best candidate satellites for the communications device to attempt to establish a wireless connection with.

If it is not true that the two satellites expected to be closest to the communications device are travelling south and the satellite expected to be third-closest to the communications device is travelling north and if the communications device is between 80-85° north latitude, the communications device may check the directions that the four satellites expected to be closest to the communications device are travelling to determine if the three satellites expected to be closest to the communications device are travelling south and the satellite expected to be fourth-closest to the communications device is travelling north. If that's the case, the communications device may determine that the satellite expected to be third-closest to the communications device and the satellite expected to be fourth-closest to the communications device are the two best candidate satellites for the communications device to attempt to establish a wireless connection with. Otherwise, the communications device may determine that the satellite expected to be closest to the communications device and the satellite expected to be third-closest to the communications device are the two best candidate satellites for the communications device to attempt to establish a wireless connection with.

If it is not true that the two satellites expected to be closest to the communications device are travelling south and the satellite expected to be third-closest to the communications device is travelling north and if the communications device is between 85-90° north latitude, the communications device may check the directions that the four satellites expected to be closest to the communications device are travelling to determine if the three satellites expected to be closest to the communications device are travelling south and the satellite expected to be fourth-closest to the communications device is travelling north. If that's the case, the communications device may determine that the satellite expected to be closest to the communications device and the satellite expected to be fifth-closest to the communications device are the two best candidate satellites for the communications device to attempt to establish a wireless connection with. Otherwise, the communications device may determine that the satellite expected to be third-closest and the satellite excepted to be fourth-closest to the communications device are the two best candidate satellites for the communications device to attempt to establish a wireless connection with.

If the communications device determines that it is between 55-90° south latitude, the communications device may consider the directions that the three satellites expected to be closest to the communications device are travelling. If the two satellites expected to be closest to the communications device are travelling south and the satellite expected to be third closest to the communications device is travelling north, the communications device may determine that the satellite expected to be closest to the communications device and the satellite expected to be third closest to the communications device are the two best candidate satellites for the communications device to attempt to establish a wireless connection with.

If it is not true that the two satellites expected to be closest to the communications device are travelling south and the satellite expected to be third-closest to the communications device is travelling north and if the communications device is between 55-60° south latitude, the communications device may determine that the two satellites expected to be closest to the communications device are the two best candidate satellites for the communications device to attempt to establish a wireless connection with.

If it is not true that the two satellites expected to be closest to the communications device are travelling south and the satellite expected to be third-closest to the communications device is travelling north and if the communications device is between 60-65° south latitude, the communications device may check the directions that the five satellites expected to be closest to the communications device are travelling to determine if the four satellites expected to be closest to the communications device are travelling south and the satellite expected to be fifth-closest to the communications device is travelling north. If that's the case, the communications device may determine that the satellite expected to be second-closest to the communications device and the satellite excepted to be third-closest to the communications device are the two best candidate satellites for the communications device to attempt to establish a wireless connection with. If it's not true that the four satellites expected to be closest to the communications device are travelling south and the satellite expected to be fifth-closest to the communications device is travelling north, the communications device may check the directions that the six satellites expected to be closest to the communications device are travelling to determine if the three satellites expected to be closest to the communications device and the satellite expected to be six-closest to the communications device are travelling north while the satellites expected to be fourth- and fifth-closest to the communications device are travelling south. In addition, the communications device also may check the azimuth angle to the satellite expected to be third-closest to the communications device to determine if it is within the range between 200-240° (where 0° is due north). If both conditions are true, the communications device may determine that the satellite expected to be closest to the communications device and the satellite expected to be third-closest to the communications device are the two best candidate satellites for the communications device to attempt to establish a wireless connection with. Otherwise, the communications device may determine that the two satellites expected to be closest to the communications device are the two best candidate satellites for the communications device to attempt to establish a wireless connection with.

If it is not true that the two satellites expected to be closest to the communications device are travelling south and the satellite expected to be third-closest to the communications device is travelling north and if the communications device is between 65-70° south latitude, the communications device may check the directions that the four satellites expected to be closest to the communications device are travelling to determine if the three satellites expected to be closest to the communications device are travelling south and the satellite expected to be fourth-closest to the communications device is travelling north. If that's the case, the communications device may determine that the satellite expected to be second-closest to the communications device and the satellite expected to be fourth-closest to the communications device are the two best candidate satellites for the communications device to attempt to establish a wireless connection with. Otherwise, the communications device may determine that the two satellites expected to be closest to the communications device are the two best candidate satellites for the communications device to attempt to establish a wireless connection with.

If it is not true that the two satellites expected to be closest to the communications device are travelling south and the satellite expected to be third-closest to the communications device is travelling north and if the communications device is between 70-75° south latitude, the communications device may check the directions that the four satellites expected to be closest to the communications device are travelling to determine if the three satellites expected to be closest to the communications device are travelling south and the satellite expected to be fourth-closest to the communications device is travelling north. If that's the case, the communications device may determine that the satellite expected to be closest to the communications device and the satellite expected to be fourth-closest to the communications device are the two best candidate satellites for the communications device to attempt to establish a wireless connection with. If it's not true that the three satellites expected to be closest to the communications device are travelling south and the satellite expected to be fourth-closest to the communications device is travelling north, the communications device may check the directions that the five satellites expected to be closest to the communications device are travelling to determine if the four satellites expected to be closest to the communications device are travelling south and the satellite expected to be fifth-closest to the communications device is travelling north. If that's the case, the communications device may determine that the satellite expected to be closest to the communications device and the satellite expected to be fourth-closest to the communications device are the two best candidate satellites for the communications device to attempt to establish a wireless connection with. Otherwise, the communications device may determine that the two satellites expected to be closest to the communications device are the two best candidate satellites for the communications device to attempt to establish a wireless connection with.

If it is not true that the two satellites expected to be closest to the communications device are travelling south and the satellite expected to be third-closest to the communications device is travelling north and if the communications device is between 75-80° south latitude, the communications device may check the directions that the four satellites expected to be closest to the communications device are travelling to determine if the three satellites expected to be closest to the communications device are travelling south and the satellite expected to be fourth-closest to the communications device is travelling north. If that's the case, the communications device may determine that the satellite expected to be closest to the communications device and the satellite expected to be third-closest to the communications device are the two best candidate satellites for the communications device to attempt to establish a wireless connection with. If it's not true that the three satellites expected to be closest to the communications device are travelling south and the satellite expected to be fourth-closest to the communications device is travelling north, the communications device may check the directions that the five satellites expected to be closest to the communications device are travelling to determine if the four satellites expected to be closest to the communications device are travelling south and the satellite expected to be fifth-closest to the communications device is travelling north. If that's the case, the communications device may determine that the satellite expected to be second-closest to the communications device and the satellite expected to be third-closest to the communications device are the two best candidate satellites for the communications device to attempt to establish a wireless connection with. Otherwise, the communications device may determine that the two satellites expected to be closest to the communications device are the two best candidate satellites for the communications device to attempt to establish a wireless connection with.

If it is not true that the two satellites expected to be closest to the communications device are travelling south and the satellite expected to be third-closest to the communications device is travelling north and if the communications device is between 80-85° south latitude, the communications device may check the directions that the four satellites expected to be closest to the communications device are travelling to determine if the three satellites expected to be closest to the communications device are travelling south and the satellite expected to be fourth-closest to the communications device is travelling north. If that's the case, the communications device may determine that the satellite expected to be third-closest to the communications device and the satellite expected to be fourth-closest to the communications device are the two best candidate satellites for the communications device to attempt to establish a wireless connection with. Otherwise, the communications device may determine that the satellite expected to be closest and the satellite expected to be third-closest to the communications device are the two best candidate satellites for the communications device to attempt to establish a wireless connection with.

If it is not true that the two satellites expected to be closest to the communications device are travelling south and the satellite expected to be third-closest to the communications device is travelling north and if the communications device is between 85-90° south latitude, the communications device may check the directions that the four satellites expected to be closest to the communications device are travelling to determine if the three satellites expected to be closest to the communications device are travelling south and the satellite expected to be fourth-closest to the communications device is travelling north. If that's the case, the communications device may determine that the satellite expected to be closest to the communications device and the satellite expected to be fifth-closest to the communications device are the two best candidate satellites for the communications device to attempt to establish a wireless connection with. Otherwise, the communications device may determine that the satellite expected to be third-closest and the satellite excepted to be fourth-closest to the communications device are the two best candidate satellites for the communications device to attempt to establish a wireless connection with.

Aspects of the present disclosure may be implemented entirely in hardware, entirely in software (including firmware, resident software, micro-code, etc.) or in combinations of software and hardware. Furthermore, aspects of the present disclosure may take the form of a computer program product embodied in one or more computer-readable media having computer-readable program code embodied thereon.

Any combination of one or more computer-readable media may be utilized. The computer-readable media may be a computer-readable signal medium or a computer-readable storage medium. A computer-readable storage medium may be, for example, but not limited to, an electronic, magnetic, optical, electromagnetic, or semiconductor system, apparatus, or device, or any suitable combination of the foregoing. More specific examples (a non-exhaustive list) of such a computer-readable storage medium include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable signal medium may be transmitted using any appropriate medium, including but not limited to wireless, wireline, optical fiber cable, radio frequency (“RF”) signals, etc., or any suitable combination of the foregoing.

Computer program code for carrying out operations for aspects of the present disclosure may be written in any combination of one or more programming languages, including object oriented programming languages, dynamic programming languages, and/or procedural programming languages.

The techniques, functionality, and operations described herein represent examples of various aspects of the present disclosure. In this regard, it should be noted that, in some alternative implementations, functions and process steps may be performed in different orders than as described herein. For example, two process steps described herein as being performed in succession may, in fact, be executed substantially concurrently, or the process steps may be executed in the reverse or other order from that described herein, depending upon the functionality involved. It will also be noted that the different techniques, functions, operations, and/or process steps can be implemented by special purpose hardware-based systems that perform the specified techniques, functions, operations, and/or process steps, or combinations of special purpose hardware and computer instructions.

While many of the techniques disclosed herein are described largely in the context of constellations of LEO communications satellites in near-polar orbits, such techniques may be employed in any of a variety of other satellite network configurations, including, for example, in satellite network configurations in orbits other than or in addition to near-polar orbits and/or LEO including MEO and other non-stationary orbits. For example, in some implementations, the techniques disclosed herein may be employed in connection with a constellation of communications satellites arranged in planes in non-polar orbits such that the planes of satellites converge over locations other than the poles. In such implementations, a communications device may take advantage of advanced knowledge of the expected locations of satellites, areas of convergence, and/or direction of travel as described herein but as adjusted for the differences in the configuration of the constellation and the orientation of the planes.

Additionally or alternatively, the techniques described herein may be used in connection with identifying and attempting to establish a wireless connection with a node in one of multiple different wireless communications networks available to a communications device. For example, the techniques described herein may be used in connection with identifying and attempting to establish a wireless connection with a node in one or more satellite communications network, one or more terrestrial cellular networks, one or more wireless local area networks, and/or one or more short-distance wireless networks available to a communications device. In one specific example, the techniques described herein may be used in combination with techniques to evaluate the quality of the different wireless networks available to the communications device at a particular point in time (e.g., based on current signal strength, available bandwidth, network congestion, and/or quality of service (“QoS”)) in connection with identifying and attempting to establish a wireless connection with a node of one such network. Additionally or alternatively, the expected continuity of the connection to a node of such networks also may be considered in connection with identifying and attempting to establish a wireless connection with a node of one such network. For example, a potential connection to a MEO satellite may be favored over a potential connection to a LEO satellite because the potential connection to the LEO satellite may be available for a shorter duration and may require inter-beam and/or inter-satellite handoffs to maintain the connection.

Furthermore, the techniques described herein also may be used in combination with additional data and/or other techniques in connection with identifying and attempting to establish a wireless connection between a communications device and a node in a wireless communications network, including a satellite communications network like satellite communications network 200 of FIG. 2, including, for example, geospatial information about the area surrounding the communications device (e.g., mountains, buildings, and/or other potential physical obstructions), actual, historical, or predicted weather patterns, and/or actual, historical, or predicted RF interference patterns. In some particular implementations, the techniques described herein may be used, or taken advantage of, by a communications device equipped with a camera or similar optical sensor or instrument that can be used to identify potential physical obstructions in proximity to the communications device. In such implementations, the communications device may use the camera to take images of or otherwise gather information about potential physical obstructions within the field of view of the camera and/or the communication device's antenna. Based on such information (e.g., the absence or presence of potential physical obstructions), the communications device may determine that it does (or, alternatively, does not) make sense to orient the communications device in the direction of a particular satellite identified according to the techniques described herein because it is (or is not) likely that the communications device will be able to successfully establish a wireless connection with the satellite because of the absence (or presence) of potential physical obstructions in the field of view.

Additionally or alternatively, in some implementations, after a communications device has identified a number of candidate satellites with which to attempt to establish a wireless connection, the communications device may consider the expected positions of the candidate satellites relative to each other and the communications device in determining how to orient (or about how to provide cues to an end user about how to orient) the communications device to facilitate the process of establishing a wireless connection with a satellite and/or to increase the likelihood of successfully doing so. In such implementations, if the communications device determines that it may be possible to orient the communications device so that the field of view of the communications device's antenna(s) includes multiple of the candidate satellites at the same time, the communications device might prioritize orienting (or providing cues to an end user to orient) the communications device such that the field of view of the communication device's antenna(s) includes those multiple candidate satellites over other orientations of the communications device and/or the communications device may decide to orient (or to provide cues to an end user to orient) the communications device such that the field of view of the communication device's antenna(s) includes the multiple candidate satellites instead of attempting to orient (or provide cues to an end user to orient) the communications device so that a specific candidate satellite is in the center of the field of view of the communication device's antenna(s).

The terminology used herein is for the purpose of describing particular aspects only and is not intended to be limiting of the disclosure. As used herein, the singular forms “a”, “an” and “the” are intended to include the plural forms as well, unless the context clearly indicates otherwise.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to explain the principles of the disclosure and the practical application, and to enable others of ordinary skill in the art to understand the disclosure with various modifications as are suited to the particular use contemplated.

What is claimed:

1. A method for accommodating communication between a personal communication device and a satellite communication system comprising a constellation of satellites in low earth orbit, comprising:
identifying likely positions of one or more satellites of a satellite communication system comprising a constellation of satellites in low earth orbit;
determining, based upon the identified likely positions of the one or more satellites, a desired orientation of a personal communication device having a non-omnidirectional antenna to potentially facilitate a wireless communication connection between the personal communication device and at least one of the one or more satellites of the satellite communication system;
providing information at a user interface of the personal communication device, the information including the desired orientation position of the personal communication device;
detecting a signal received from the at least one of the one or more satellites of the satellite communication system; and
determining whether the at least one of the one or more satellites is capable of establishing the wireless communication connection between the personal communication device and the at least one of the one or more satellites of the satellite communication system.

2. The method of claim 1, wherein identifying likely positions of the one or more satellites of the satellite communication system comprises:
accessing ephemeris data regarding the one or more satellites of the satellite communication system that is preloaded into the personal communication device; and
identifying likely positions of the one or more satellites of the satellite communication system using the ephemeris data.

3. The method of claim 2, further comprising using the ephemeris data to determine a current direction of the one or more satellites of the satellite communication system and a current azimuth angle to the one or more satellites of the satellite communication system to determine the desired orientation of the personal communication device to potentially facilitate the wireless communication connection.

4. The method of claim 3, further comprising:
determining a current position of the personal communication device using a global navigation satellite system (GNSS); and
using the current position of the personal communication device to determine the position of the personal communication device to potentially facilitate the wireless communication connection.

5. The method of claim 2, wherein the ephemeris data includes information regarding expected position, footprint and beam patterns for the at least one of the one or more satellites of the satellite communication system.

6. The method of claim 1, wherein the personal communication device comprises an accelerometer and a direction sensor, and further comprising determining a current orientation of the personal communication device relative to the likely positions of the one or more satellites of the satellite communication system.

7. The method of claim 1, wherein identifying likely positions of one or more satellites of a satellite communication system comprises identifying likely positions of a first satellite and a second satellite of the satellite communication system, and further comprising:
determining that the first satellite is likely to be a better candidate of the first satellite and the second satellite to potentially facilitate a wireless communication connection between the personal communication device and the at least one of the one or more satellites of the satellite communication system;
providing an instruction at the user interface to orient the personal communication device toward the likely position of the first satellite;
after providing the instruction to orient the personal communication device toward the likely position of the first satellite, determining that the first satellite is not a good candidate to potentially facilitate a wireless communication connection between the personal communication device and the at least one of the one or more satellites of the satellite communication system; and
providing an instruction at the user interface to orient the personal communication device toward the likely position of the second satellite, in response to determining that the first satellite is not a good candidate to potentially facilitate a wireless communication connection between the personal communication device and the at least one of the one or more satellites of the satellite communication system.

8. The method of claim 2, wherein identifying likely positions of one or more satellites of a satellite communication system comprises identifying likely positions of a first satellite and a second satellite of the satellite communication system, and the ephemeris data regarding the one or more satellites of the satellite communication system includes ephemeris data regarding the first satellite and the second satellite, and further comprising:
determining expected positions of the first satellite and the second satellite relative to each other; and
wherein determining a desired orientation of the personal communication device to potentially facilitate a wireless communication connection between the personal communication device and at least one of the one or more satellites of the satellite communication system comprises using the expected positions of the first satellite and the second satellite relative to each other to determine the desired orientation of the personal communication device to potentially facilitate a wireless communication connection between the personal communication device and at least one of the one or more satellites of the satellite communication system.

9. The method of claim 1, wherein identifying likely positions of one or more satellites of a satellite communication system comprises identifying likely positions of a first satellite, a second satellite and a third satellite of the satellite communication system, and further comprising:
determining that the first satellite is likely to be a better candidate of the first satellite, the second satellite and the third satellite to potentially facilitate a wireless communication connection between the personal communication device and the at least one of the one or more satellites of the satellite communication system;
determining a first desired orientation of the personal communication device toward the first satellite;
determining a second desired orientation of the personal communication device toward the second satellite and the third satellite, simultaneously; and
providing an instruction at the user interface to orient the personal communication device to the second desired orientation position.

10. The method of claim 1, wherein identifying likely positions of one or more satellites of a satellite communication system comprising a constellation of satellites in low earth orbit comprises:
providing an instruction at the graphical user interface of the personal communication device to scan above at least a portion of a horizon of the earth;
receive signals from at least a first satellite, a second satellite, and a third satellite of the satellite communication system, respectively, during the scan above at least a portion of a horizon of the earth;
measure respective signal strengths of the received signals;
determine a likelihood of establishing a wireless communication connection with each of the first satellite, the second satellite, and a third satellite of the satellite communication system, respectively, based upon the measured respective signal strengths of the received signals;
determining that the likelihood of establishing a wireless communication connection with the first satellite is higher than the likelihood of establishing a wireless communication connection with the second satellite and the likelihood of establishing a wireless communication connection with the third satellite; and
wherein the desired orientation of the personal communication device comprises an orientation suitable to potentially facilitate a wireless communication connection between the personal communication device and the first satellite of the satellite communication system.

11. The method of claim 10, wherein providing an instruction at the graphical user interface of the personal communication device to scan above at least a portion of a horizon of the earth comprises providing an instruction at the graphical user interface of the personal communication device to scan above approximately 360 degrees of a horizon of the earth.

12. The method of claim 1, further comprising establishing the wireless communication connection between the personal communication device and the at least one of the one or more satellites of the satellite communication system.

13. The method of claim 1, wherein the information provided at the user interface of the personal communication device comprises visual cues to a user of the personal communication device.

14. The method of claim 1, wherein the information provided at the user interface of the personal communication device comprises auditory cues to a user of the personal communication device.

15. The method of claim 1, wherein the information provided at the user interface of the personal communication device comprises haptic cues to a user of the personal communication device.

16. The method of claim 2, wherein the ephemeris data includes initial ephemeris data and further comprising:
receiving, at the personal communication device, updated ephemeris data regarding the one or more satellites of the satellite communication system;
storing the updated ephemeris data at the personal communication device; and
identifying likely positions of the one or more satellites of the satellite communication system, using the updated ephemeris data.

17. The method of claim 1, wherein determining a desired orientation of the personal communication device to potentially facilitate a wireless communication connection between the personal communication device and at least one of the one or more satellites of the satellite communication system comprises:
receiving information from at least one other personal communication device regarding its past ability to establish communications with the one or more satellites of the satellite communication system; and
using the information received from the at least one other personal communication device to determine the desired orientation.

18. The method of claim 17, wherein the information received from the at least one other personal communication device is received via WiFi or Bluetooth communications between the personal communication device and the at least one other personal communication device.

19. The method of claim 17, wherein the information received from the at least one other personal communication device is received from one of the one or more satellites of the satellite communication system.

20. The method of claim 17, wherein the at least one other personal communication device comprises a plurality of other personal communication devices and wherein the information received from the at least one other personal communication device is received from each of the plurality of other communication devices.
